(19) United States
(12) Patent Application Publication
(10) Pub. No.: US 2016/0379263 A1
(43) Pub. Date: Dec. 29, 2016

(54) SYSTEMS AND METHODS OF DELIVERING ADVERTISING OVER NETWORKS

(71) Applicants: David Uhalley, Novato, CA (US); Brian H. Boyajian, Petaluma, CA (US)

(72) Inventors: David Uhalley, Novato, CA (US); Brian H. Boyajian, Petaluma, CA (US)

(21) Appl. No.: 15/191,397

(22) Filed: Jun. 23, 2016

Related U.S. Application Data
(60) Provisional application No. 62/183,587, filed on Jun. 23, 2015.

(51) Int. Cl. G06Q 30/02

(52) U.S. Cl. CPC G06Q 30/0264; G06Q 30/0277; G06Q 30/0261

(57) ABSTRACT

A method of online advertising in a communications network in which an advertiser's teaser ad is presented to an end user using a network connected device on a publisher's site or channel, but only when a channel associated with the advertiser's teaser ad is live.

### CROSS REFERENCES TO RELATED APPLICATIONS

The present application claims priority to, and the benefit of the filing date of, U.S. Provisional Patent Application No. 62/183,587, filed Jun. 23, 2015 (Jun. 23, 2015), which application is incorporated in its entirety by reference herein.

### STATEMENT REGARDING FEDERALLY SPONSORED RESEARCH OR DEVELOPMENT

Not applicable.

THE NAMES OR PARTIES TO A JOINT RESEARCH AGREEMENT

Not applicable.

INCORPORATION BY REFERENCE OF MATERIAL SUBMITTED ON A COMPACT DISC

Not applicable.

### BACKGROUND OF THE INVENTION

Field of the Invention

The present invention relates most generally to advertising, and more particularly to on-line advertising, and still more particularly to a system and method of internet-enabled advertising and marketing wherein a teaser ad component of a publisher's advertisement is presented with real-time communications features and content, but only when the publisher's associated channel is live.

Background Discussion

The internet has effectively eclipsed all other media for promoting goods and services. There is, however, growing evidence indicating that many online advertisements remain either unnoticed, or in many cases, considered to be annoyances that are thus consciously and purposefully ignored by the end user. Originally, online advertising involved only text. Later, banner ads were introduced, which included still artwork design and photographs. Eventually, the artwork was animated so that the movement would attract and keep a viewer's attention. The most recent online trend is video advertising, and it is growing at a rapid rate. Regardless of the type of advertisement displayed, there have not been any significant changes with regard to what happens after an end user selects (e.g., “clicks” on) a displayed advertisement, and then in how the ad content is presented to—and communicated with—the end user.

### BRIEF SUMMARY OF THE INVENTION

The present invention involves methods of delivering, measuring, managing, and displaying, only live advertisements (“Living Ads”) that are easily accessible and highly engaging. Living Ads content is only available in real-time, offering a truly immersive and inherently human, thus natural experience for the end user. Online real-time communications are quickly becoming mainstream and are readily available, providing an opportunity for a unique and highly effective online advertising system and methods.

The invention employs a real-time communications (“RTC”) System, which provides unique methods ideally suited for online advertising. These benefits directly affect all those involved in an online advertisement lifecycle: the end user, the advertiser, and the publisher; and they include online networks (social networks and others) hosting sophisticated online advertising networks of their own. The system is designed for real-time communications from the ground up, and because of its customized and unique RTC architecture, it offers such advertising methods in ways that conventional advertising systems simply cannot.

Conventional internet advertising does not involve an actual live person(s), and/or experience, associated with the ad. Most traditional online ads, when selected, direct the end user to the advertiser's website or to an external, third-party web page that cannot support real-time communications. For this reason, many of the features offered by the present invention would be difficult or impossible to achieve without having access, and taking full advantage, of the unique properties of the inventive RTC system.

The system is also custom-designed to closely mimic the real world experience, insofar as the inventive methods offer real-time communications features found in everyday real world events, activities, and engagements. This system and its methods allow for this real world experience, and then enhance that experience, with unique online features. Mixing the “traditional” real world communications model with internet communications methods results in a powerful hybrid, offline/online, real-time communications system that is powerful, flexible, and truly unique.

The inventive system and methods, however, are compatible with conventional closed, open, and hybrid online networks. The system and methods of the present invention are also compatible with traditional, and modern, online advertising networks and methods.

Among the many advantages of the present invention, first and foremost, the Living Ad teaser only appears when its associated channel is live. The channel online/offline control option is a crucial component of the proposed invention. If the channel associated with an ad is set to offline, the teaser ad will not display on a publisher's site or channel. The teaser ad deactivates as soon as its associated channel is switched to offline, resulting in extra incentive for an interested end user to select the ad before it's potentially no longer available. The teaser ads can be configured to run on a first-come/first-served, basis, along with a maximum capacity set.

An advertiser can control how many of its teaser ads are displayed. Once the maximum impressions and/or “click-thrus” are reached, the ad “times out” and self-destructs on the publisher.

The advertiser can also set limits on how many products and/or services are being sold, and the advertisement can self-destruct on the publisher once that limit is reached.

A counter can be included on an ad, notifying end users how many items are left. Or, the number of items remaining for sale can remain unknown to the end user; providing additional incentive for an interested end user to click-thru before the ad disappears on the publisher.

The advertiser also has control over the number of simultaneous end users (number of current click-thrus and/or regular viewers) with RTC privileges on its channel. As soon as an end user who has been granted RTC privileges leaves a channel, another teaser advertisement can be displayed, only allowing a predetermined set number of end users with RTC privileges on the channel at a time. Referred to as the “revolving door” method, the method involves: one person out, one person in, and this can be ongoing until the maximum number of teaser ad click-thrus or CPMs (cost per 1,000 impressions) are reached. It should be noted that this “revolving door” method closely resembles the real world experience as mentioned in the Introduction of this document. As with a brick and mortar store, channels also have control over the number of simultaneous visitors. (See FIGS. 3-5, and FIG. 8, described fully below.)

The advertiser, as part of the ad campaign, can also be granted (by the System) a prearranged set of RTC features and/or tools based on a type of promotion. For example, some advertisers may wish to present a live video broadcast while others may prefer individually-selected video and/or audio chats, telepresence, and IM.

The advertiser's channel, by default, can begin with pure peer-to-peer (P2P) communications and convert to broadcast, along with media server(s), based on the amount of traffic. This on-demand media server method, specifically geared for online advertising, is truly unique and very effective. As used herein, “broadcast” bears the meaning of transmitting from one to many.

An advertising campaign can also be dynamic, and easily scalable, based on the type of advertisement experience being presented on its associated channel.

End users can be presented with opportunities to win rewards and/or prizes if they click-thru the teaser ad to experience the ad content on its associated channel. This type of ad gamification is unique and an incredibly effective marketing strategy, particularly due to its RTC features.

Advertisers have control over their teaser ad “roll out” frequency rates. For example, some advertisers, particularly those opting for pure P2P communications, may wish to limit the number of end users on their channels to a bare minimum at a time. In these cases, they can set their teaser ads to be released on a slower roll out rate in relation to advertisers who wish to broadcast to a large number of end users on their channel simultaneously, such ads being released to publishers on a more rapid roll out scheduling rate. Teaser ads can also be adjusted to roll out to publishers only when their associated channel has not reached the maximum number of simultaneous end users with RTC privileges. (See FIGS. 6-8.)

Advertisers have control over the amount of time a teaser ad is displayed on a publisher. Such control enables an advertiser to ensure that end users never know exactly how long an ad will be available, thus providing an extra incentive for those end users truly interested in the ad to click-thru.

Advertisers have control over the amount of time they allow the end user to view their channels. Special conditions can also be arranged. For example, if an end user participates in RTC, including instant messaging (IM), his or her time allowed on the channel may be increased or the time limit may no longer apply. As with all the channel configurations (with or without advertising), the channel provider is in full control. This method prevents end users from sitting idle on channels and potentially preventing others from experiencing the advertiser's content, much as with the “revolving door” method previously described.

Teaser ads can be requested by end users. The advertiser(s) can accept or deny any end user, based on the user profile, or for any other reason. If the request is accepted, the teaser ads can be released at any time to the specific end users requesting them.

Invitations can be sent out by advertisers to specific end users based on their profiles. An RSVP can be included as part of the invitation and either accepted or denied by the end user for any reason. If the invitation is accepted, the teaser ads can be released at any time to the specific end users agreeing to receive them.

As with real world seminars and online webinars, questions asked on an advertiser's channel can be handled by operators and addressed selectively during or after the ad broadcast has completed. In some cases, interaction may not be necessary such as during special live events.

As with conventional online advertising methods, teaser ads can be location based. Using geolocation technologies, including end users' IP addresses, different advertisements can be displayed on the publisher at the same time, and based on the end user's location. However, unlike conventional advertising methods, Living Ads are always live and offer an enhanced experience for the end user, regardless of location. Ultimately, Living Ads offer a more intimate experience with the advertiser's product, no matter where the end user resides.

Accessing a promotion featuring such RTC options is particularly unique and advantageous, for manipulating and/or operating remote physical devices (“telepresence”) associated with the advertisement. Such physical objects can include digital cameras, robots, and/or any electronic mobile device. The system architecture permits easy access, along with control, of network-connected devices, offering an end user a unique perspective of the advertiser's product. (See FIGS. 11-12)

With conventional advertising, the end user is essentially a spectator of a polished, often unrealistic, representation of a product and/or service. With Living Ads, the end user becomes an actual participant in the advertisement. The advertiser can no longer fully control how an advertisement is seen by prospective buyers. Instead, the end user is now in charge of how he views the product being promoted. This is a significant change in how the internet-based advertising world operates.

With the present invention, advertisers are forced into being more transparent and honest with customers, especially on advertising channels where end users have the option of directing the advertisement. The result: a more level playing field where not only the advertisers with the largest ad campaigns thrive. Instead, advertisers that are most open and honest about their products are more likely to succeed, regardless of the sizes of the advertising budgets. Advertisers caught being deceptive will lose market share quickly, particularly in a real-time communications environment such as this proposed invention. “Live cameras don't lie.” The consumer now has an advantage, and advertisers must conform to this new (marketing) reality.

Selected and/or random end users can be chosen (by the advertiser) to have a telepresence option available on an associated channel, (see FIGS. 11-12).

Living Ads assist in converting push advertising into pull advertising. End users will recognize, and embrace, the trust factor associated with products promoted using these proposed advertising methods. Ultimately, customers will seek out products they recognize as being advertised on Living Ads.

Ad measurement methods: Advertisers can track, in real-time, individual end user behavioral patterns.

Advertisers, on membership-based websites, can instantly be provided with information on (logged in) end users entering their associated channel.

Advertisers on membership-based websites can target end users demographically based on their user profiles.

End users, including those who are not logged in on membership-based sites, are immediately recognized when entering an advertiser's channel. Real-time communications, under channel provider discretion, are immediately available to the end user, without any login, downloads, installs, and/or special privileges when entering a channel.

Ad management methods: Advertisers can make real-time adjustments based on individual end user behavioral patterns. For example, ads can be personalized and targeted to specific end users, resulting in customized ads—“quality vs. quantity”—as opposed to bulk ad campaigns used in conventional online advertising campaigns. Though it must be noted that Living Ads can promote bulk ad campaigns as well.

The inventive system contains network condition-based algorithms that factor in and adjust ad-related data accordingly, all in real-time. Poor network conditions, primarily, affect those ads (and associated channels) that rely strictly on core peer-to-peer communications. With this proactive method in place, channels are notified in real-time of any network-related issues, allowing them to adjust how they present their promotions. The algorithms factor in dynamic network conditions and make the same, or similar, accommodations for channels broadcasting live and using media servers. Channels can notify their customers in real-time of current network conditions. The types of ads can be adjusted in real-time based on network conditions. The number of ads can be adjusted in real-time based on network conditions. (See FIGS. 9, 10.) The display of ads can be adjusted in real-time based on network conditions. The cost of ads can be adjusted in real-time based on network conditions.

Micropayment options are offered to all advertisers. Micropayments are particularly beneficial for advertisers that may fall under the “classifieds” type of promotions. These types of small budget advertisers don't have the volume of traffic on their associated channels compared to the larger, live broadcast, types of advertisements. Living Ads, however, are ideal for smaller ad campaigns, including “classifieds” type ads. Micropayments, as a result, offer an affordable option for those ad campaigns that depend on core P2P advertising.

Core P2P advertising is also facilitated and more advantageous using the present invention, because the consumer purchases products and/or services directly from the source, with no middleman involved. The result is a quicker, more informative, and transparent/honest transaction. The ability of the system to offer 1-1 real-time advertising communications is truly unique to the interne, yet similar to real world occurrences. Furthermore, pure P2P communications is inherently more secure than the traditional client/server architecture.

The size, type, or even placement of teaser Living Ads are insignificant compared to conventional online ads. Video advertising has proven to be an effective type of display advertising because of their ability to grab the end user's attention but, end users observing display ads, beyond brand awareness, really don't provide much benefit for the advertiser. The advertiser's goal is for the end user to select the ad, and make the purchase. The proposed teaser ads can be in any display format. However, once an end user recognizes that any Living Ad, when selected, results in a live feed, the size or type of ad really will not matter.

Teaser ads can be shown as a live video feed, unlike current ad promotions showing taped video or stills. This type of ad display will prove to be much more effective than standard video advertising.

Pricing can be adjusted per type of teaser ad display, text ads being the least expensive and live video ads being the most expensive.

Core P2P online advertising is, technically, more simple than conventional online advertising. When there is no use of a media server, communication between advertiser and the end user is direct, client-to-client.

From a business perspective, core P2P advertising using the present invention is more cost effective than standard online advertising because there is little to no hosting costs involved.

Summarily stated, Living Ads translates into a dignified advertising model that respects end users by presenting their promotion in a live and transparent format, thereby greatly diminishing the chance of any false advertising. Showing respect for the end user will be reciprocally returned to the advertiser who will be supported for being so open with promotions. The publisher will also be appreciated by guests for running such teaser ads.

In short, Living Ads provide the incentive for click-thrus, and the methods for communicating with the customer, in a real-time environment. This vastly increases the advertiser's chances at making a sale.

The foregoing summary broadly sets out the more important features of the present invention so that the detailed description that follows may be better understood, and so that the present contributions to the art may be better appreciated. There are additional features of the invention that are described in the detailed description of the preferred embodiments of the invention and which form the subject matter of claims set out herein.

### GLOSSARY

Real-Time Communications Components Defined

System: An online real-time communications platform comprising dedicated and/or ephemeral channels. The System is not limited to run on just one website or network. The system can be licensed to run on independent networks, or even appearing to run independently on external websites or networks through the use of white labeling options.

Channel: Advertisement content details (product and/or service) are displayed here, only if the channel is associated with a Living Ad. The channel consists of, but not limited to, real-time communication tools such as instant messaging (text), audio, video, and built-in telepresence capabilities for remote manipulation of physical devices. The channel resides within the aforementioned real-time communications system. All “teaser ads”, see below, must have an associated channel, internal to a set website and/or network, or external, potentially as an independent white label web page, and/or network. The channel may be dedicated, but it may also be ephemeral, enduring only for the duration of the RTC ad. Thus, there are two types of channels: one dedicated and going live, wherein the advertiser engages with an end user in a real-time communication; another in which the advertiser goes live but has no dependency on the status of the ephemeral/temporary channel.

Channel Provider: Person(s) responsible for configuring and managing a channel. As indicated in the channel definition, a channel does not have to be associated with an advertisement.

Advertisement Components

Ad server: Serves advertisements to a publisher for display to end users.

Ad database: Stores advertisements that may be pulled by an ad server.

Living Ads: Online advertisements, presented live, with real-time communications features. The Living Ads advertisement is comprised of two components: “teasers”, or “teaser ads”, residing on the publisher, and content details, residing on its associated channel. It should be noted that ad(s) and Living Ad(s) are used interchangeably throughout this document.

Key Parties/Entities Included in the Invention Description

Advertiser: Company, or person, promoting the advertisement.

Publisher: Web page presenting the teaser advertisements. A publisher may be an external web page, or another internal (within a set network) channel that offers advertisements.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic view showing a simplified advertising cycle as executed by the inventive system, presented to and experienced by an end user;

FIG. 2 is a schematic overview showing an ad cycle in which an end user selects a teaser ad displayed on a publisher channel, which triggers the ad presentation to the end user and commences bidirectional real-time communication (“RTC”);

FIG. 3 is a schematic view showing accessibility to a channel limited by a predetermined number of simultaneous end users granted RTC access;

FIG. 4 is a schematic view showing the ad cycle when a channel has reached a maximum number of simultaneous end users with RTC access such that further end users are denied RTC privileges while still allowed access to the channel;

FIG. 5 is a schematic view showing a general overview of a “revolving door” method of regulating end user access to a channel;

FIG. 6 is a schematic view showing a channel with programmed teaser ads released to publishers when a predetermined maximum number of simultaneous end users with RTC access has not been reached;

FIG. 7 is a schematic view showing the same channel with a set limit on the number of simultaneous end users granted RTC access, with teaser ads programmed not to be released to publishers when the predetermined maximum number of simultaneous end users with RTC access has been reached;

FIG. 8 is a schematic view showing a revolving door method and a teaser ad “roll out” method;

FIG. 9 is a schematic view illustrating a channel with teaser ads programmed for release to publishers only if network conditions are sufficiently favorable;

FIG. 10 is a schematic view showing another scheme for a channel with teaser ads programmed for release to publishers only if the network conditions are good, wherein the network conditions are poor;

FIG. 11 is a schematic view showing a “telepresence” marketing method; and

FIG. 12 is a schematic view showing a “telepresence” method in which an end user remotely controls a mobile robot located at a car dealership advertising automobiles for sale.

### DETAILED DESCRIPTION OF THE INVENTION

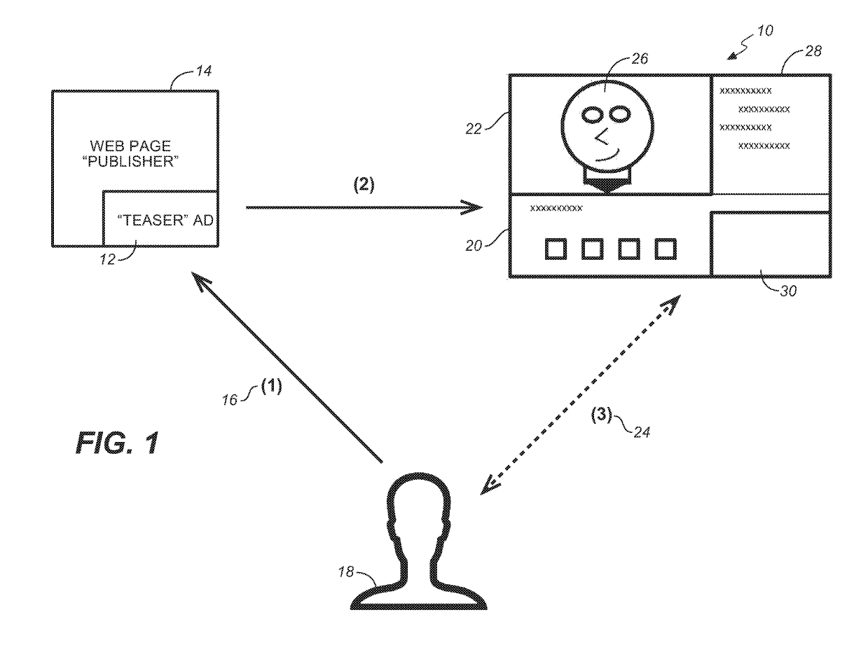

Referring to FIGS. 1 through 12, wherein like reference numerals refer to like components in the various views, there is illustrated therein a new and improved network-enabled advertising and marketing system and method wherein a teaser ad component of a publisher's advertisement is presented with real-time communications features and content, but only when the publisher's associated channel is live, generally referred to herein as “Living Ads.”

FIG. 1 illustrates a first preferred embodiment 10 of the inventive system and method, wherein the Living Ads life cycle includes the following six events: (1) First a teaser ad 12 is displayed, and this is presented on a web page publisher's site 14. (2) Second, a click-thru is triggered 16; that is, a teaser ad is selected by the end user 18. (3) Third, content 20 is presented to the end user 18 on the ad's associated channel 22. This is the Living Ads experience. (4) Fourth, there is interaction 24 involving Real-Time Communications (RTC) between the advertiser 26 and the end user 18. (5) Fifth, a confirmation may take place, involving an agreement 28 being reached between the advertiser and the end user (which will naturally vary according to an advertiser's objectives). (6) Sixth, there is a payment transaction 30, wherein money is exchanged between the advertiser 26 and the end user 18. FIG. 1 shows the most general overview of a Living Ads life cycle. The end user 18 selects a teaser ad 12 displayed on the publisher (web page) 14 which triggers the teaser ad's associated channel 22 to be presented to the end user. The end user and the channel thereafter interact in real-time until the cycle is completed.

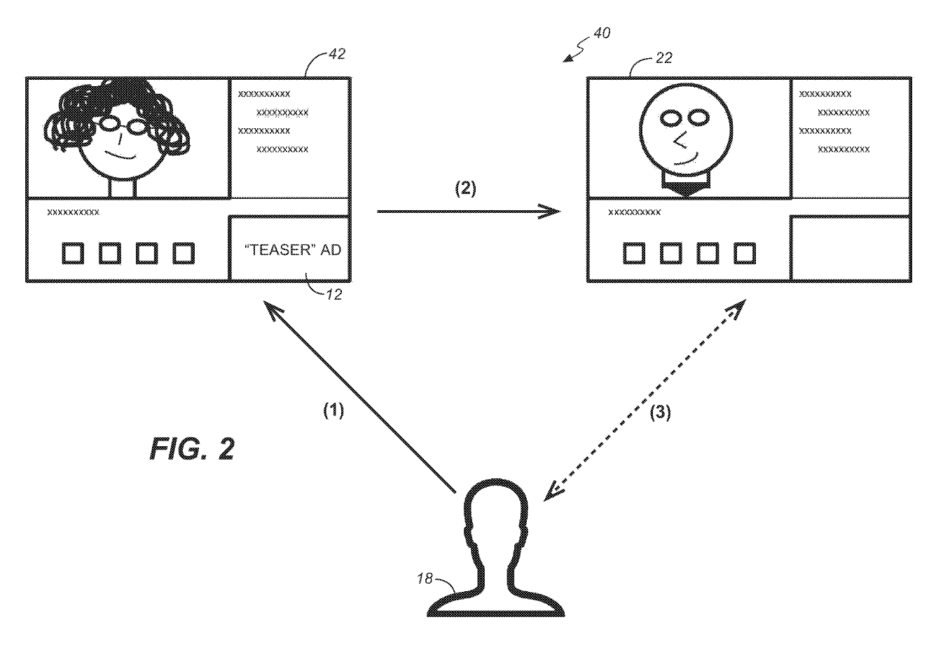

Next, referring to FIG. 2, there is shown a general overview of another embodiment of a Living Ads life cycle 40, wherein an end user 18 selects a teaser ad 12 displayed on the publisher (channel) 42 to trigger the teaser ad's associated channel 22 to be presented to the end user 18. The end user and the channel are now interacting in real-time.

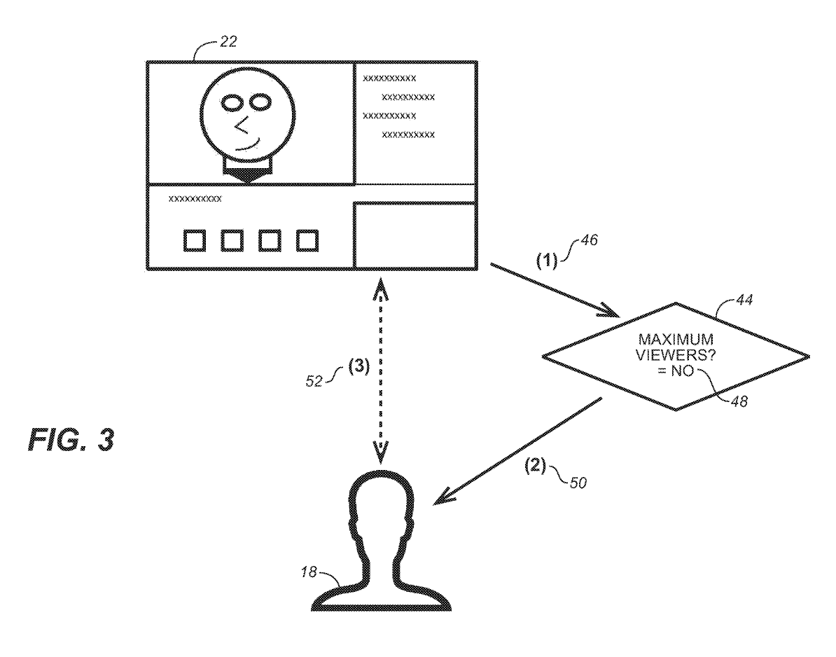

Referring next to FIG. 3, it is seen that a channel 22 has set a limit on the number of simultaneous end users granted RTC access 44. In this drawing, number of current end users on the channel 22 with RTC privileges is checked 46 and determined that the maximum number has not been reached 48. The end user 18 is thus given immediate access 50 to the channel with RTC privileges and bidirectional communications 52 are initiated.

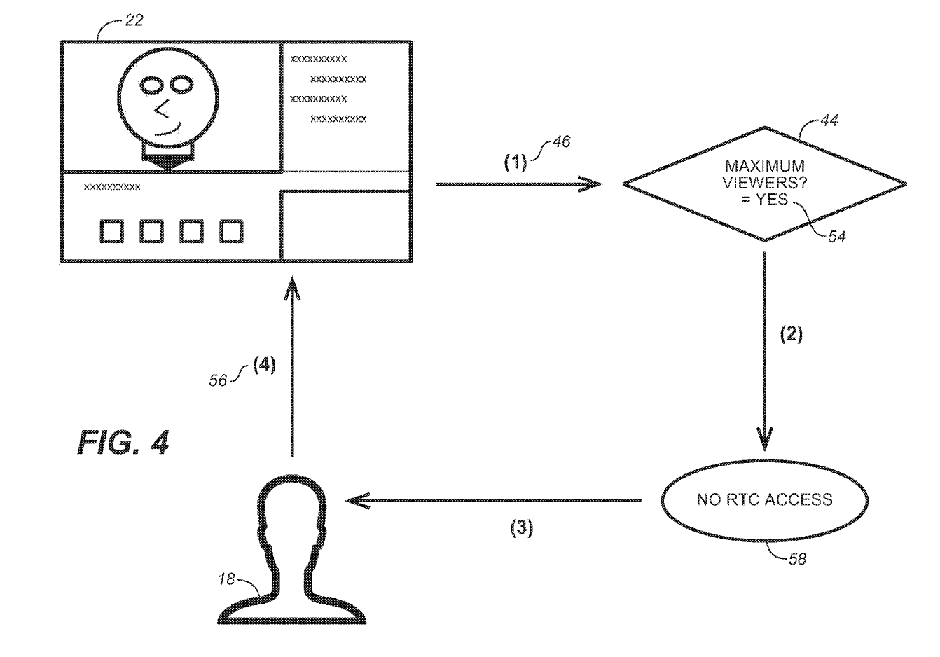

FIG. 4 illustrates a channel 22 viewed by a user 18 but which has reached a maximum number of simultaneous end users with RTC access using the decision rules for limiting RTC access 44. The number of current end users on the channel 22 with RTC privileges is checked 46 and it is determined that the maximum number has been reached 54. The end user 18 is given immediate unidirectional access 56 to the channel 22, but without RTC privileges 58.

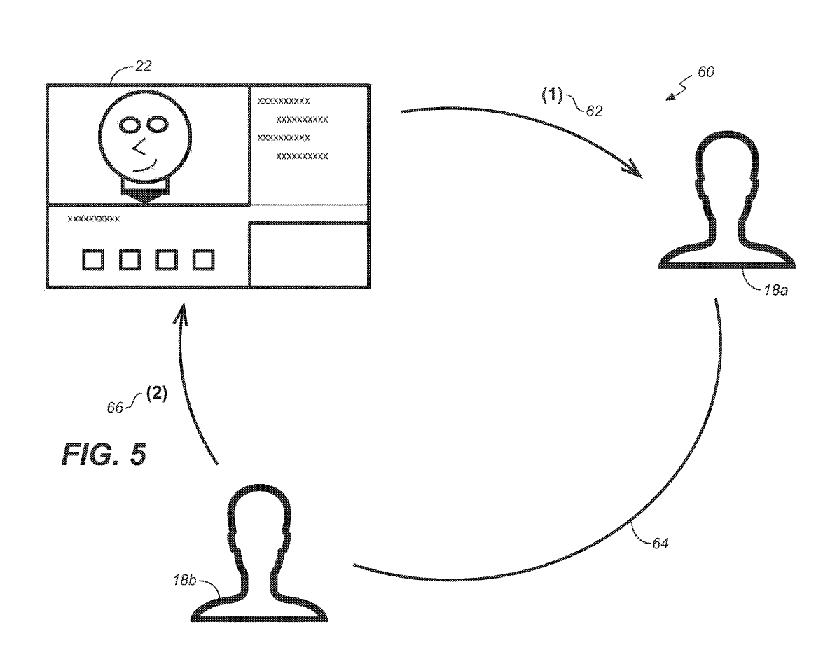

FIG. 5 provides a general overview of a “revolving door” method 60, wherein as one end user granted RTC privileges exits the Living Ads cycle, another end user is granted RTC access: one out, one in. In this drawing, one end user 18a granted RTC privileges 62 exits the channel 22, immediately leaving an opening 64 for another end user 18b to enter the channel with RTC privileges 66.

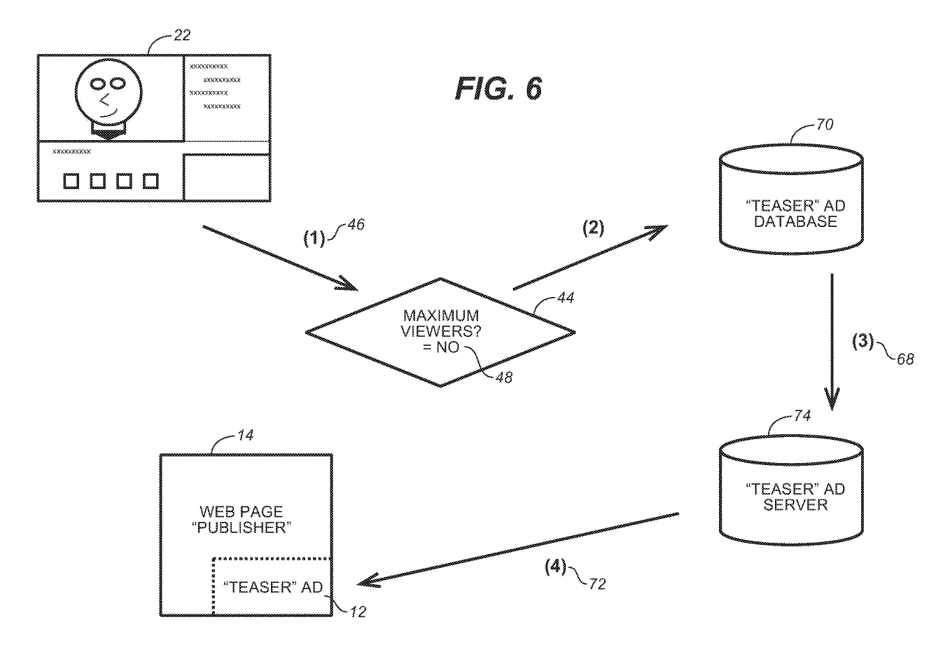

FIG. 6 shows how a channel 22 participating in a Living Ads campaign may have set a limit 44 on the number of simultaneous end users granted RTC access, and has programmed their teaser ads 12 to be released (“rolled out”) to publishers 14 only if the maximum number of simultaneous end users with RTC access has not been reached. In this drawing, the number of current end users on the channel 22 with RTC privileges is checked 46 and determined that the maximum number has not been reached 48. The channel's associated teaser ad is pulled 68 from the teaser ad database 70 and served 72 to the publisher 14 from a teaser ad server 74.

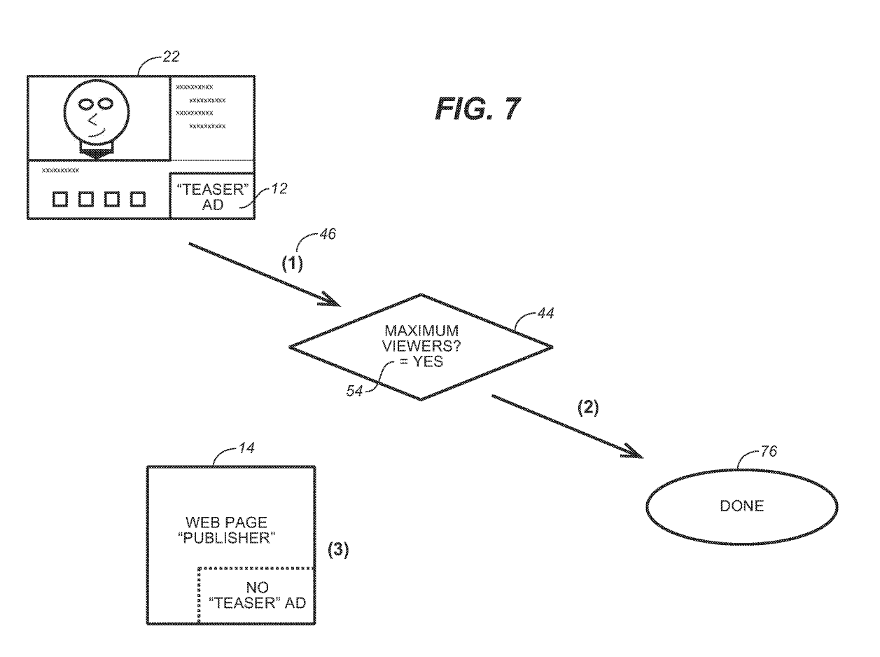

FIG. 7 shows a channel 22 participating in a Living Ads campaign, which has set a limit 44 on the number of simultaneous end users granted RTC access, and has programmed teaser ads 12 to be released (“rolled out”) to publishers 14 only if the maximum number of simultaneous end users with RTC access has not been reached. In this drawing, the number of current end users on the channel 22 with RTC privileges is checked 46 and it is determined that the maximum number has in fact been reached 54. This precludes the teaser ad from being released 76 to the publisher 14.

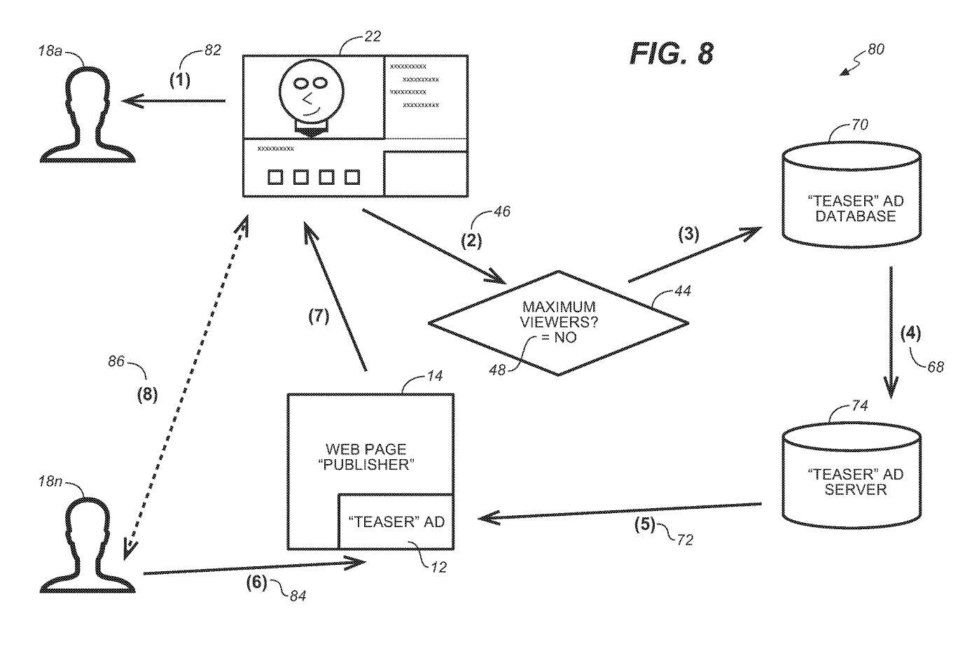

FIG. 8 illustrates a scheme 80 involving both the “revolving door” method and, related, teaser ad “roll out” to publisher. In this drawing, an end user 18a granted RTC privileges 82 exits the channel. The number of current end users on the channel 22 with RTC privileges is then checked 46 and it is determined that the maximum number has not been reached 48. The channel's associated teaser ad 12 is pulled 68 from the teaser ad database 70 and served 72 to the publisher 14 from the teaser ad server 74. The end user 18n selects 84 the teaser ad 12 displayed on the publisher (web page) 14 which triggers the teaser ad's associated channel 22 to be presented to the end user 18n. The end user and the channel are now interacting in real-time 86.

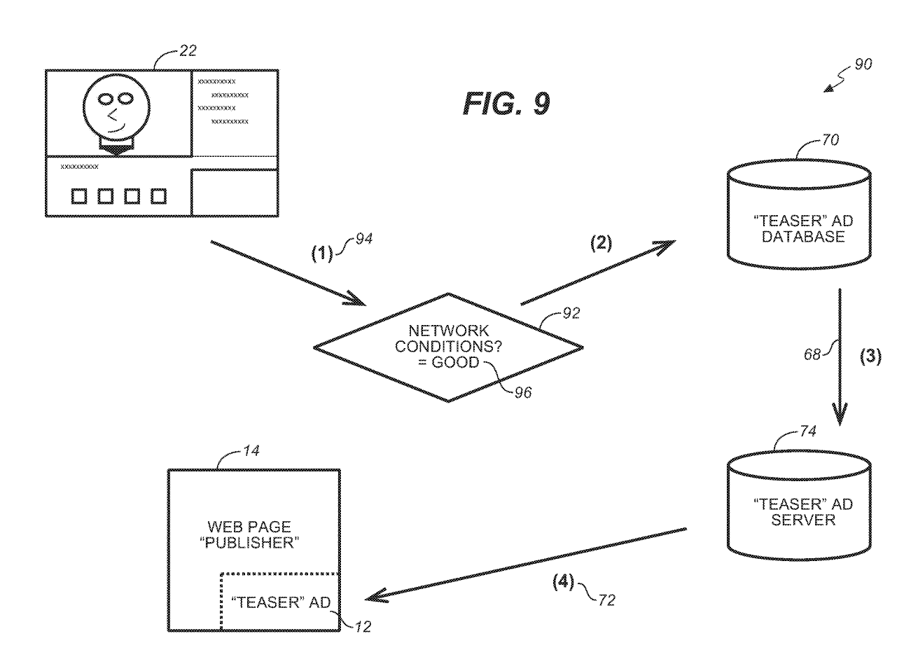

FIG. 9 illustrates an alternative embodiment 90 in which a channel 22 participating in a Living Ads campaign includes teaser ads 12 programmed to make a network conditions check 92 and to release (“rolled out”) to publishers 14 only if the network conditions are good. In this drawing, a network conditions check is performed 94 and it is determined that the conditions are good 96, so the channel 22 allows additional end users with RTC privileges at this time. The channel's associated teaser ad 12 is pulled 68 from the teaser ad database 70 and served 72 to the publisher 14 from the teaser ad server 74.

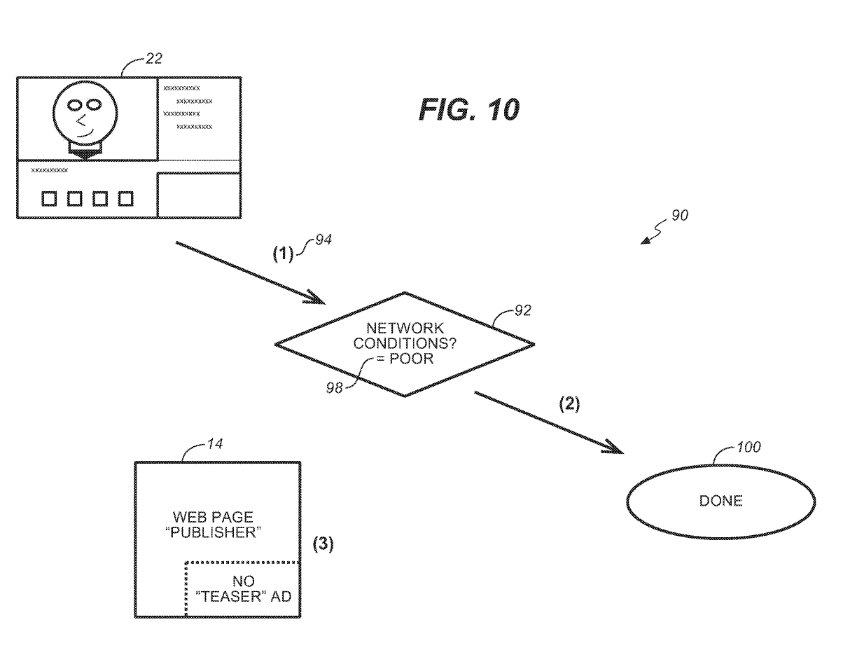

FIG. 10 shows an embodiment 90 having a channel similarly participating in a Living Ads campaign that has programmed teaser ads released (“rolled out”) to publishers only if the network conditions are good 92. In this drawing, a network conditions check is performed 94 and it is determined that the conditions are poor 98, so the channel 22 does not allow for additional end users with RTC privileges at this time; resulting in no teaser ad being released 100 to the publisher 14.

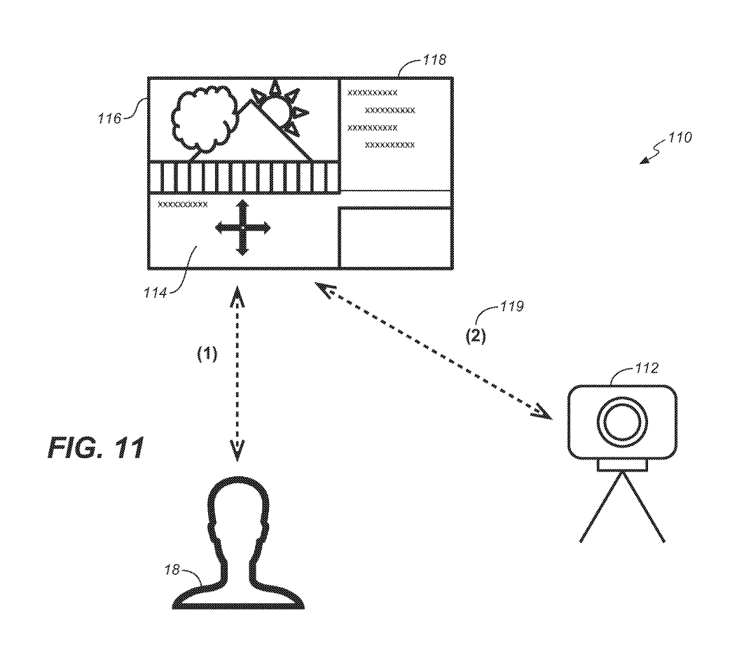

FIG. 11 is a schematic overview 110 of a “telepresence” method. In this drawing, an end user 18 remotely controls a camera 112 with PTZ (Pan, Tilt, Zoom) functionality, with navigation controls 114 provided through the web page 118 of an establishment—e.g., a bed & breakfast—featuring its mountain view 116 on the channel or web page 118. The end user utilizes the navigation controls offered on the channel which, in turn, send commands 119 in real-time to the camera. The end user is able to experience this view from the B&B as if he/she were actually physically present. This is an especially effective marketing method.

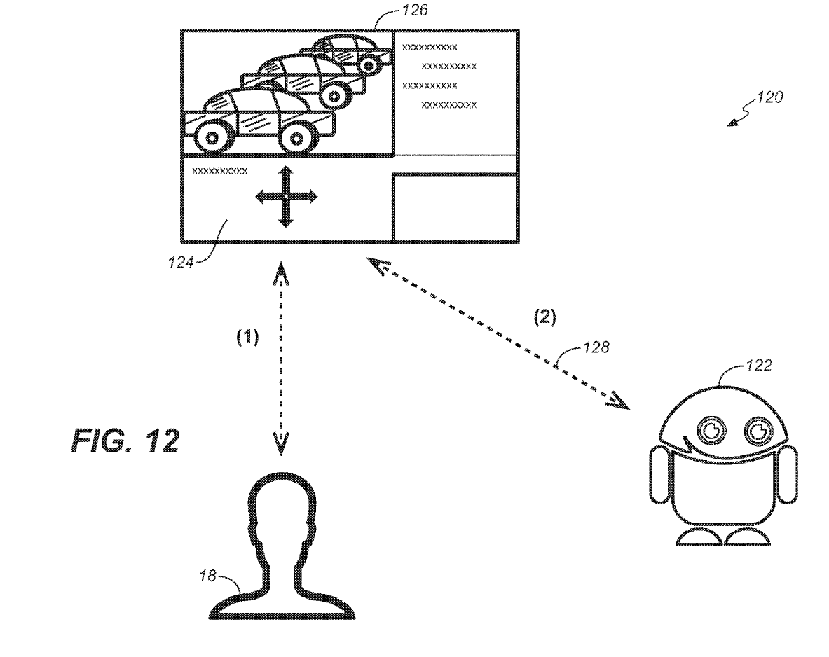

Finally, FIG. 12 provides a general overview of another “telepresence” method 120. In this drawing, an end user 18 is remotely controlling a mobile robot 122, located at a car dealership advertising automobiles now for sale. The end user utilizes the navigation controls 124 offered on the channel 126 which, in turn, sends commands 128, in real-time, to the robot. The end user is able to experience the car dealership as if he/she were actually physically present at the dealership. This, too, is a highly effective marketing method.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method of online advertising in a communications network, comprising presenting to an end user using a network connected device a teaser ad provided by advertiser on a publisher's site or channel when a channel associated with the advertiser's teaser ad is live.

2. The method of claim 1, further including prohibiting the teaser ad from being displayed to the end user when the associated channel is set to offline.

3. The method of claim 1, further including deactivating the teaser ad when the associated channel is switched to offline.

4. The method of claim 1, further including configuring the teaser ad to run on a first-come/first-serve basis.

5. The method of claim 1, further including limiting the maximum number of click thrus that can access the teaser ad simultaneously.

6. The method of claim 5, further including timing out the teaser ad once the maximum impressions and/or click-thrus are reached, the ad “times out” and “self-destructs” on the publisher.

7. The method of claim 1, further including controlling the number of teaser ads displayed.

8. The method of claim 1, further including controlling the number of simultaneous end users permitted to have real-time communications (“RTC”) privileges on the associated channel based on click-thrus.

9. The method of claim 8, wherein the controlling step is a revolving door, wherein when an end user granted RTC privileges leaves a channel, another teaser advertisement can be displayed, thereby allowing only a predetermined number of end users with RTC privileges on the associated channel at the same time.

10. The method of claim 9, further including continuing the revolving door until a maximum number of teaser ad click-thrus or CPMs are reached.

11. The method of claim 10, further including presenting a live video broadcast, an individually-selected video, audio chats, instant messaging, manipulating remote physical devices, or any combination thereof.

12. The method of claim 1, further including beginning the advertiser's channel with peer-to-peer (P2P) communications, and converting to broadcast based on the amount of traffic.

13. The method of claim 1, further including presenting end users can with opportunities to win rewards and/or prizes if they click-thru the teaser ad to experience the ad content on its associated channel.

14. The method of claim 1, further including controlling teaser ad roll out frequency rate.

15. The method of claim 1, further including controlling the amount of time a teaser ad is displayed on a publisher.

16. The method of claim 1, further including controlling the amount of time end users are permitted to view content on an associated channel.

17. The method of claim 16, further including controlling channel configurations, thereby preventing end users from remaining idle on associated channels.

18. The method of claim 1, wherein teaser ads are location based.

19. The method of claim 1, further including providing a controllable device that may be manipulated remotely by an end user accessing a teaser ad or on its associated channel, the remote physical devices including digital cameras, robots, and/or any electronic mobile device.

20. The method of claim 19, wherein the end user is a participant in the advertisement and in how he views the service or product advertised.
